(19) United States
(12) Patent Application Publication
(10) Pub. No.: US 2017/0101147 A1
(43) Pub. Date: Apr. 13, 2017

(54) VEHICLE CONSPICUITY/SIGNALING SYSTEM

(71) Applicant: SUZUKI MOTOR CORPORATION, Hamamatsu-Shi (JP)

(72) Inventor: Kei HASEGAWA, Hamamatsu-Shi (JP)

(73) Assignee: SUZUKI MOTOR CORPORATION, Hamamatsu-Shi (JP)

(21) Appl. No.: 15/270,099

(22) Filed: Sep. 20, 2016

(30) Foreign Application Priority Data
Oct. 13, 2015 (JP) 2015-202271

(51) Int. Cl. B62J 6/00; B60Q 1/34

(52) U.S. Cl. CPC B62J 6/001; B62J 6/005; B60Q 1/346; B62J 2006/006; B62J 2300/002; B62J 2300/008; B62J 2300/0013; B60Q 2400/50

(57) ABSTRACT

A vehicle conspicuity/signaling system includes a projector configured to project a light pattern onto a road surface, a speed/acceleration detection unit configured to detect a vehicle speed and an acceleration, a bank angle detection unit configured to detect a bank angle, a chassis behavior detection unit configured to detect a behavior of a chassis, and a projector control unit configured to change a projection status of the light pattern projected from the projector on the basis of the detection results of these detection units.

### CROSS-REFERENCE TO RELATED APPLICATIONS

This application is based upon and claims the benefit of priority of the prior Japanese Patent Application No. 2015-202271, filed on Oct. 13, 2015, the entire contents of which are incorporated herein by reference.

### BACKGROUND OF THE INVENTION

Field of the Invention

The present invention relates to a vehicle conspicuity/signaling system for informing other drivers of presence or a travel state of a vehicle (main vehicle).

Description of the Related Art

As a device for informing other drivers or pedestrians of presence or a travel state of a main vehicle, lighting devices such as a tail lamp or a brake lamp are employed. The brake lamp informs other drivers or pedestrians around the main vehicle of occurrence of braking by blinking the light when a driver performs braking. However, other drivers neighboring to the main vehicle may be difficult to accurately recognize a proper distance from the main vehicle or a travel state of the main vehicle just by the tail lamp or the brake lamp of the main vehicle. In addition, a driver or the like of the main vehicle may also be difficult to accurately recognize proper distances from other vehicles just by the tail lamps or the brake lamps of other vehicles. For example, since a motorcycle has a size generally smaller than those of other four-wheeled vehicles, other drivers neighboring to the motorcycle may excessively reduce an inter-vehicle driving distance relative to a proper distance. Furthermore, the proper inter-vehicle driving distance between the main vehicle and a neighboring vehicle varies depending on a travel state of the main vehicle. However, solely using the tail lamp or the brake lamp, it is difficult to accurately inform other drivers or pedestrians around the main vehicle of the proper inter-vehicle driving distance that may change depending on a travel state.

In Japanese Laid-open Patent Publication No. 2005-306337, there is discussed a projector configured to project an image for indicating a passing direction at an intersection onto a road surface ahead in a travel direction on the basis of the data provided from a navigation device. In addition, Japanese Laid-open Patent Publication No. 2004-155404, there is discussed a headlamp capable of changing an irradiation range depending on a bank angle of a motorcycle chassis. In this manner, Japanese Laid-open Patent Publication Nos. 2005-306337 and 2004-155404 discuss a technique of providing a driver with predetermined information or obtaining a driver's field of view by projecting light onto the ground surface from a vehicle. Unfortunately, they do not consider a technology of informing other drivers around the main vehicle of presence or a travel state of the main vehicle.

Patent Document 1: Japanese Laid-open Patent Publication No. 2005-306337

Patent Document 2: Japanese Laid-open Patent Publication No. 2004-155404

### SUMMARY OF THE INVENTION

In view of the aforementioned problems, it is therefore an object of the present invention to provide a vehicle conspicuity/signaling system capable of informing other drivers or pedestrians around a main vehicle of a travel state of the main vehicle.

According to an aspect of the present invention, there is provided a vehicle conspicuity/signaling system including: a projector configured to project a light pattern onto a road surface; and a control unit configured to change a projection status of the light pattern projected from the projector depending on a travel state of the vehicle.

The vehicle conspicuity/signaling system described above may further include a detection unit configured to detect the travel state of the vehicle. The control unit may change the projection status of the light pattern projected from the projector depending on the travel state detected by the detection unit.

The detection unit may detect at least one of a vehicle speed and an acceleration of the vehicle, and the control unit may change the projection status of the light pattern projected from the projector depending on at least one of the vehicle speed and the acceleration detected by the detection unit.

The detection unit may detect a bank angle of the vehicle, and the control unit may change the projection status of the light pattern projected from the projector depending on the bank angle of the vehicle detected by the detection unit.

The vehicle conspicuity/signaling system described above may further include a detection unit configured to detect a manipulation for the vehicle from a driver. The control unit may change the projection status of the light pattern projected from the projector depending on the manipulation for the vehicle detected by the detection unit.

The control unit may change the projection status of the light pattern projected from the projector when the detection unit detects a decelerating manipulation for the vehicle.

The control unit may change the projection status of the light pattern projected from the projector when the detection unit detects at least one of a manipulation for changing a travel route of the vehicle and a manipulation for the direction indicator.

The vehicle conspicuity/signaling system described above may further include a distance detection unit configured to detect a distance from a neighboring vehicle. The control unit may change the projection status of the light pattern projected from the projector depending on the distance from other vehicles detected by the distance detection unit.

The control unit may change the projection status of the light pattern projected from the projector when a relative velocity to a neighboring vehicle is equal to or higher than a threshold value.

The control unit may change the projection status of the light pattern projected from the projector when a relative velocity to a neighboring vehicle is equal to or lower than the threshold value.

The control unit may change the projection status of the light pattern projected from the projector when any other vehicle trying to overtake is detected.

The control unit may control the projector such that the light pattern is projected to indicate outer edges of an area which includes a position of the vehicle and is larger than the vehicle.

The area may have a trapezoidal shape widening forward of the vehicle.

The vehicle conspicuity/signaling system described above may further include a detection unit configured to detect a vehicle speed of the vehicle.

The control unit may change a size of the area depending on the vehicle speed of the vehicle detected by the detection unit.

The vehicle conspicuity/signaling system described above may further include a detection unit configured to detect a bank angle of the vehicle.

The projection direction of the light from the projector may be changed depending on the bank angle of the vehicle detected by the detection unit.

### BRIEF DESCRIPTION OF THE DRAWINGS

FIG. 1 is a right side view schematically illustrating an exemplary configuration of a motorcycle having a conspicuity/signaling system;

FIG. 2A is a diagram schematically illustrating an exemplary configuration of a projector;

FIG. 2B is a diagram schematically illustrating an exemplary configuration of a projector;

FIG. 3A is a plan view exemplarily illustrating arrangement positions of the projectors and light patterns projected onto a road surface from the projectors;

FIG. 3B is a plan view exemplarily illustrating arrangement positions of the projectors and light patterns projected onto a road surface from the projectors;

FIG. 3C is a plan view exemplarily illustrating arrangement positions of the projectors and light patterns projected onto a road surface from the projectors;

FIG. 3D is a plan view exemplarily illustrating arrangement positions of the projectors and light patterns projected onto a road surface from the projectors;

FIG. 4 is a block diagram illustrating an exemplary configuration of the conspicuity/signaling system;

FIG. 5A is a side view schematically illustrating a first operation;

FIG. 5B is a plan view schematically illustrating the first operation;

FIG. 5C is a diagram illustrating exemplary contents of a table used in the first operation;

FIG. 6A is a front view schematically illustrating a second operation;

FIG. 6B is an exemplary table used in the second operation;

FIG. 7A is a plan view schematically illustrating a third operation;

FIG. 7B is a diagram illustrating exemplary contents of a table used in the third operation;

FIG. 8A is a diagram schematically illustrating a fifth operation;

FIG. 8B is a diagram schematically illustrating the fifth operation;

FIG. 8C is a diagram schematically illustrating the fifth operation;

FIG. 9A is a plan view schematically illustrating a sixth operation;

FIG. 9B is a plan view schematically illustrating the sixth operation;

FIG. 10A is a plan view schematically illustrating a seventh operation; and

FIG. 10B is a diagram illustrating an exemplary table used in the seventh operation.

### DETAILED DESCRIPTION OF THE PREFERRED EMBODIMENTS

Preferred embodiments of the present invention will now be described in detail with reference to the accompanying drawings. In the following description, a configuration of a vehicle conspicuity/signaling system according to an embodiment of the present invention is employed in a motorcycle by way of example. For the purpose of simplicity, in the following embodiment, the “vehicle conspicuity/signaling system” may also be referred to simply “conspicuity/signaling system.” In each drawing, “Fr” denotes a front side of the motorcycle having the conspicuity/signaling system, “Rr” denotes a rear side, “Up” denotes an upper side, “Lw” denotes a lower side, “R” denotes a right side, and “L” denotes a left side.

### <General Configuration of Motorcycle>

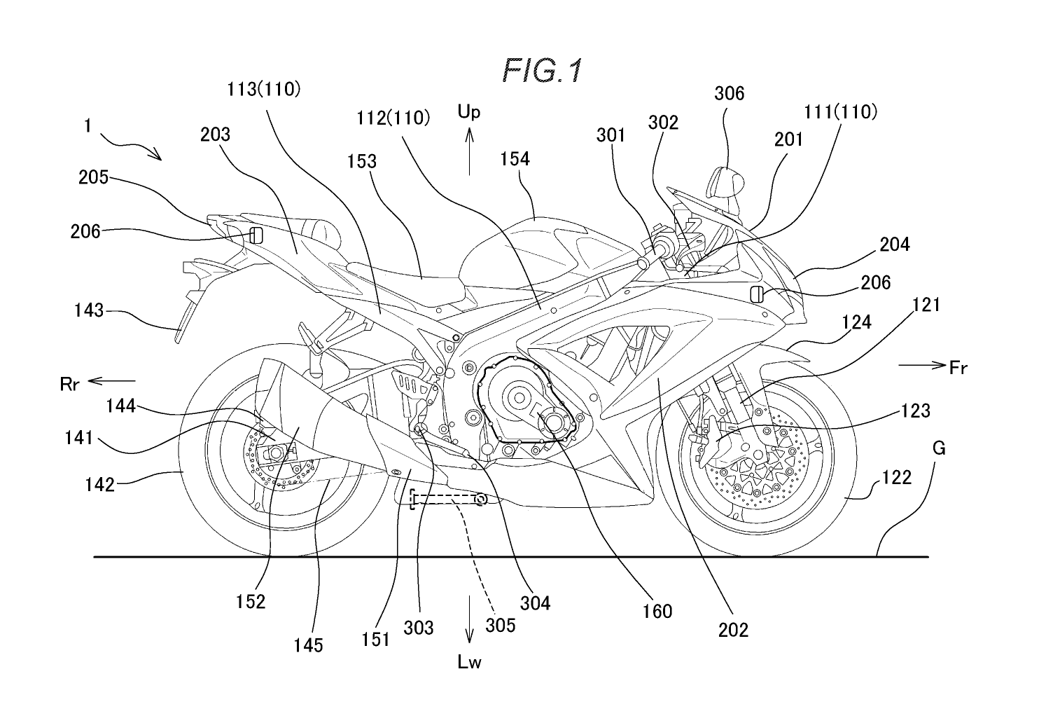

First, a general configuration of a motorcycle 1 having the conspicuity/signaling system 7 will be described with reference to FIG. 1. FIG. 1 is a right side view schematically illustrating an exemplary configuration of the motorcycle 1 having the conspicuity/signaling system 7. In this embodiment, an on-road type motorcycle will be described by way of example. However, the type of the motorcycle is not limited thereto.

As illustrated in FIG. 1, the motorcycle 1 includes a chassis 110, an engine unit 160, a plurality of fairings, and other predetermined auxiliary members or accessories.

The chassis 110 of the motorcycle 1 has a steering head pipe 111 and a pair of left and right body frames 112. The steering head pipe 111 has a pipe shape inclined rearward. A pair of left and right body frames 112 is provided with front ends integrally bonded to the steering head pipe 111 and extend rearward and obliquely downward from the steering head pipe 111 with a gap widening in the vehicle width direction. A pair of left and right seat rails 113 is provided in rear parts of the body frames 112. A pair of left and right seat rails 113 support a seat 153 where a driver is seated and extend rearward and obliquely upward from the rear parts of the body frames 112 with a predetermined gap in the vehicle width direction. Each part of the chassis 110 is formed of a steel material or an aluminum alloy material, and they are integrally bonded by welding and the like.

In the front side of the chassis 110, a steering shaft (hidden and not shown in FIG. 1), a pair of left and right front forks 121, and a front wheel 122 are provided. The steering shaft is inserted into the steering head pipe 111 and is rotatably supported by the steering head pipe 111. A pair of left and right front forks 121 is connected to the steering shaft using a bracket or the like and is rotated in synchronization with the steering shaft. The front wheel 122 is rotatably supported by the lower ends of the pair of left and right front forks 121. The front wheel 122 is installed with a brake disk that rotates in synchronization. The pair of left and right front forks 121 is provided with a front wheel brake caliper 123 for braking the front wheel 122 and a front fender 124 that covers an upper side of the front wheel 122.

Each of the left and right front forks 121 is installed with a handle 301 in its upper end. The handle 301 includes left and right handle bars (handle grips). The right handle bar is provided with a front wheel brake lever 302 for manipulating the front wheel brake caliper 123. The left handle bar is provided with a clutch lever for manipulating the clutch. In addition, a control lever (control switch) for manipulating a direction indicator 206 is provided in the vicinity of any one of the left and right handle bars. Furthermore, in the front side of the handle 301, an instrument unit in which various instruments and gauges such as a speedometer are assembled is disposed.

A swing arm 141 is vertically swingably (in a pitching direction) connected to the rear part of the chassis 110. A rear wheel 142 is rotatably supported by the rear end of the swing arm 141. A rear wheel brake caliper 144 for braking the rear wheel 142 is provided in the swing arm 141. A driven sprocket rotating in synchronization with the rear wheel 142 is installed in the left side of the rear wheel 142. A drive chain 145 is looped around the driven sprocket and a driving sprocket of the engine unit 160. In addition, the rotary power output from the engine unit 160 is transmitted to the rear wheel 142 through the driving sprocket and the drive chain 145. A brake disk rotating in synchronization with the rear wheel 142 is provided in the right side of the rear wheel 142. Furthermore, a shock absorber (not shown) is provided between the chassis 110 and the swing arm 141, so that a vibration or shock transmitted from the rear wheel 142 to the chassis 110 is absorbed or alleviated by the shock absorber. A rear fender 143 that covers the upper side of the rear wheel 142 is provided above the rear wheel 142. Moreover, a tail light 205 (brake lamp) is provided in the rearmost part of the motorcycle 1 or the vicinity thereof.

A seat 153 where a rider (such as a driver or a passenger) is seated is provided on the seat rails 113. A fuel tank 154 is provided on the body frames 112 in front of the seat 153. Left and right footpegs 303 where foots of a rider (driver) are loaded are provided in the lower parts of the body frames 112 under the seat 153. The left and right footpegs 303 are assembled into the body frames 112 using a hinge mechanism or the like, so that they can be hinged up when it collides with a road surface G or the like. A rear wheel brake lever 304 for manipulating the rear wheel brake caliper 144 is provided in the vicinity of the right footpeg 303, and a selector for manipulating a transmission mechanism is provided in the vicinity of the left footpeg 303. A kickstand 305 is provided in the lower part of the body frame 112. The kickstand 305 is connected to the body frame 112 using a hinge mechanism or the like, so that the motorcycle 1 can be parked by standing the kickstand 305. Note that any one of the configurations known in the art may be employed in the footpegs 303 or the kickstand 305 without a particular limitation.

The motorcycle 1 is provided with a plurality of fairings. The fairings are exterior members of the motorcycle 1 and cover each part to form appearance of the motorcycle 1. The fairings include a front fairing 201, a side fairing 202, and a rear fairing 203. The front fairing 201 covers the front part of the motorcycle 1 such as the front forks 121 and the vicinity thereof. The side fairing 202 covers the left and right sides of the motorcycle 1 such as the engine unit 160 and the vicinity thereof. The rear fairing 203 covers the rear part of the motorcycle 1 such as seat rails 113 and the vicinity thereof. Each fairing is a shell-like member formed of, for example, a synthetic resin material through injection molding or the like. The each fairing is detachably installed in the chassis 110 using screws or the like.

A headlamp 204 is provided in the front end of the front fairing 201. Direction indicators 206 are provided in the left and right sides of the headlamp 204. In addition, a rearview mirror 306 is provided in the upper part of the front fairing 201. Note that, although the tail light 205 and the direction indicators 206 are provided in the rear fender 143 in FIG. 1, they may also be provided in the rear fairing 203.

The engine unit 160 is disposed under a pair of left and right body frames 112 of the chassis 110 and is suspended to the chassis 110 using a plurality of engine mounts. The engine unit 160 also serves as a strength member of the motorcycle 1. The engine unit 160 includes a crankcase (also referred to as a “crankcase assembly”), a cylinder block, a cylinder head, and a cylinder head cover.

A crank chamber is provided in the vicinity of the front side inside the crankcase, and a transmission housing is provided in the vicinity of the rear side inside the crankcase. A crankshaft is rotatably housed in the crank chamber. A clutch and a gearshift mechanism are provided inside the transmission housing. The clutch is configured to switch connection or disconnection of the rotary power between the crankshaft and the gearshift mechanism. Any one of various types of wet multi-plate clutches known in the art may be employed as the clutch. The gearshift mechanism performs a gearshift operation for the rotary power transmitted from the crankshaft through the clutch and transmits it to the rear wheel 142. As the gearshift mechanism, any one of constant mesh type gearshift mechanisms known in the art is employed by way of example.

The cylinder block is provided over the vicinity of the front side of the crankcase (that is, where the crank chamber is provided). Inside the cylinder block, a predetermined number of cylinders (combustion chambers) are provided. Inside the cylinders, pistons (not shown) are reciprocatably housed, and each piston is connected to the crankshaft through a connecting rod. The cylinder head is provided on the cylinder block. In the cylinder head, an intake port, an exhaust port, an intake valve, an exhaust valve, and a valve driving mechanism are provided. The intake port is a passage of a gas mixture of the fuel and the air in each cylinder. The exhaust port is an exhaust passage. The intake and exhaust valves are configured to open or close the intake and exhaust ports, respectively. The valve driving mechanism drives the intake and exhaust valves to be opened or closed. The cylinder head cover is provided on the cylinder head to cover the valve driving mechanism provided in the cylinder head.

An air cleaner is provided over the cylinder head and the cylinder head cover. The air cleaner receives and purifies the combustion air used in the engine unit 160. The air cleaner and each intake port are connected to each other through an intake passage such that the air can pass therebetween. In addition, each intake passage is provided with a throttle body for controlling a flow rate of the combustion air. In this configuration, the air flowing to the air cleaner flows to each cylinder from each intake port while the flow rate of the air is controlled (adjusted) by the throttle body.

One end (upstream side end) of the exhaust pipe 151 as a passage of the exhaust gas is connected to the exhaust port provided in the cylinder head. A sound muffler 152 is connected to the other end (downstream side end) of the exhaust pipe 151. The sound muffler 152 is arranged, for example, in the lateral side of the rear wheel 142. The exhaust gases generated in each cylinder are discharged to the outside through the exhaust ports of each cylinder, the exhaust pipe 151, and the sound muffler 152.

### <Configuration of Projector>

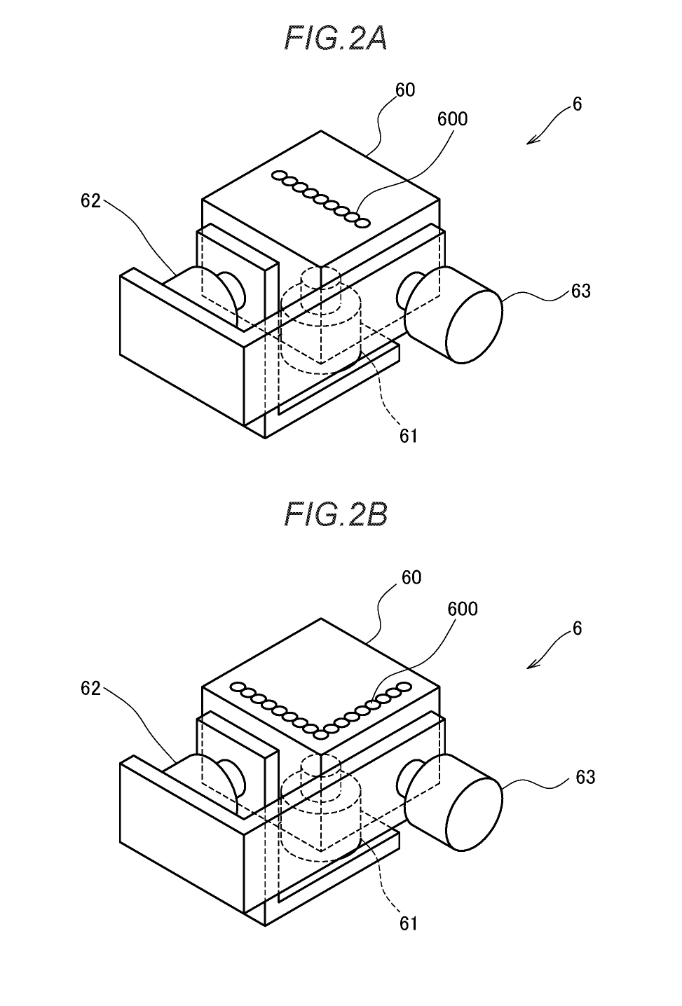

Next, an exemplary configuration of the projector 6 disposed in the motorcycle 1 will be described with reference to FIGS. 2A and 2B. FIGS. 2A and 2B are diagrams schematically illustrating an exemplary configuration of the projector 6. FIG. 2A illustrates an exemplary configuration of the projector 6 configured to project a straight light pattern P onto the road surface G, and FIG. 2B illustrates an exemplary configuration of the projector 6 configured to project an L-shaped light pattern P onto the road surface G. As illustrated in FIGS. 2A and 2B, the projector 6 includes a light source 60, a first driving mechanism 61, a second driving mechanism 62, and a third driving mechanism 63.

The light source 60 projects a predetermined light pattern P onto the road surface G. The light source 60 has a plurality of light-emitting elements 600 arranged to match the projected light pattern P. If a straight light pattern P is projected onto the road surface G, a plurality of light-emitting elements 600 are arranged side by side in a straight shape. If an L-shaped light pattern P is projected onto the road surface G, a plurality of light-emitting elements 600 are arranged side by side in an L-shape. In this manner, by appropriately arranging a plurality of light-emitting elements 600, it is possible to appropriately set the shape of the light pattern P projected onto the road surface G. Any one of light-emitting elements known in the art may be employed as the light-emitting element 600. For example, any one of various LED packages may be employed as the light-emitting element 600. Alternatively, laser diodes may also be employed. The color of the light (wavelength region) emitted from the light-emitting element 600 is not particularly limited. Alternatively, light-emitting element capable of emitting a plurality of colors of light, such as a multi-color LED package, may also be employed as the light-emitting element 600. In this configuration, it is possible to change the color of the projected light pattern P.

The light source 60 may have a projection lens or a light guide shaped to match the projected light pattern P. That is, instead of projecting a predetermined light pattern P by arranging the light-emitting elements 600, the predetermined light pattern P may also be projected using a shape of the projection lens or the light guide. For example, a so-called line laser that projects a straight light pattern P using a single light source may also be employed. The light pattern P projected onto the road surface G from the light source 60 is not limited to the straight shape or the L-shape. Alternatively, the light pattern P projected onto the road surface G from the light source 60 may include, for example, a circular shape, a circular arc shape, an X-shape, and the like. In short, any configuration of the light source 60 may be employed as long as it can project a predetermined light pattern P onto the road surface G.

The first driving mechanism 61 is capable of rotating the light source 60 around its optical axis (rotation with respect to a center of the emitted light). The second and third driving mechanisms 62 and 63 are configured to change the direction of the optical axis L of the light source 60 (that is, a light-emitting direction). Further, the second and third driving mechanisms 62 and 63 are configured to change the direction of the optical axis L of the light source 60 to be different at an angle of 90° with each other. Each of the first to third driving mechanisms 61, 62, and 63 has an actuator such as a serve motor and changes the rotation of the light source 60 and the direction of the optical axis L by virtue of a driving force of the actuator. In this configuration, using the first driving mechanism 61, it is possible to change the direction of the light pattern P projected onto the road surface G, that is, rotate the projected light pattern P. Furthermore, using the second and third driving mechanisms 62 and 63, it is possible to change the position of the light pattern P projected onto the road surface G and, in particular, a distance from the motorcycle 1.

Note that any configuration may be employed in the first to third driving mechanisms 61, 62, and 63 without a particular limitation. In short, any configuration may be employed in the first to third driving mechanisms 61, 62, and 63 as long as it can rotate the light pattern P projected onto the road surface G from the light source 60 and change the position of the light pattern P projected onto the road surface G from the light source 60.

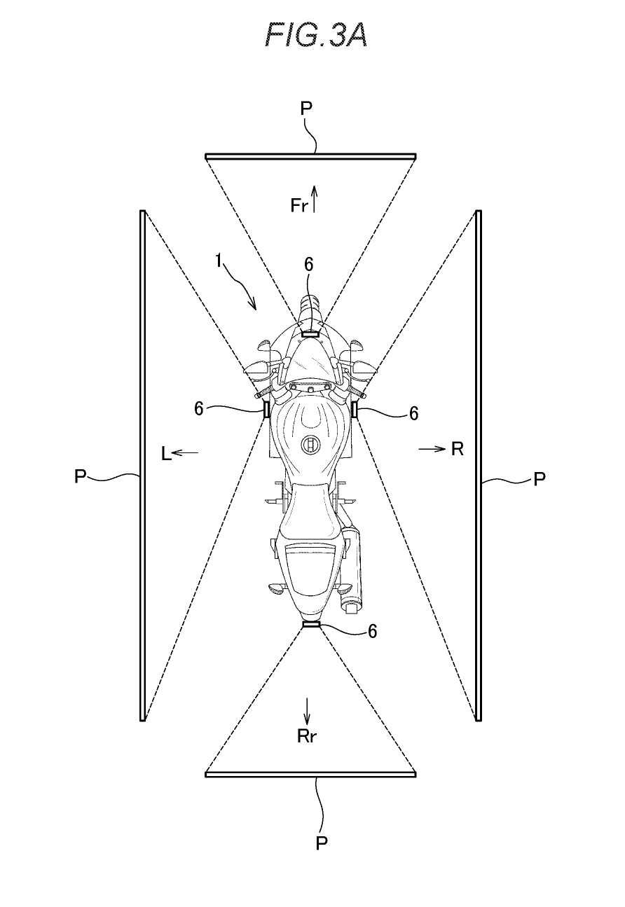

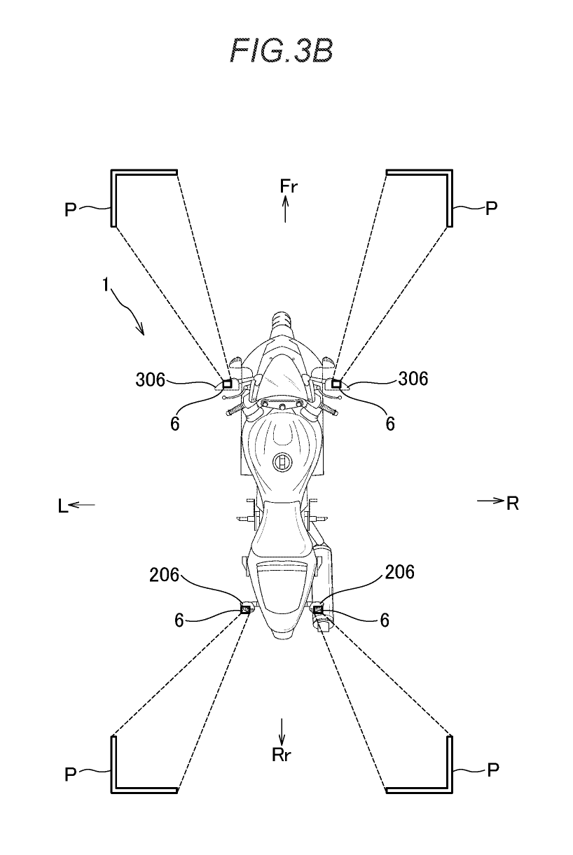

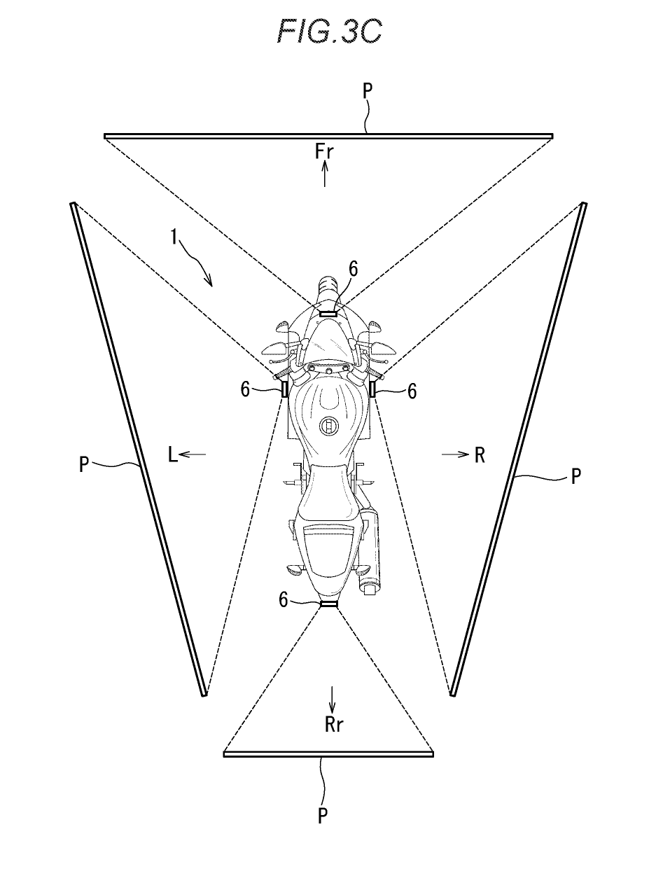

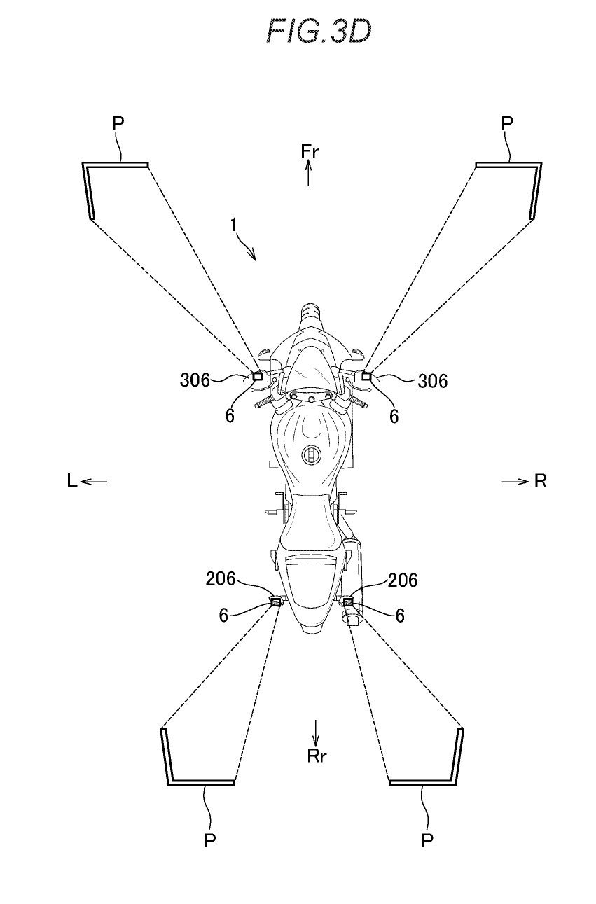

FIGS. 3A to 3C are plan views exemplarily illustrating the arrangement position of the projector 6 and the light pattern P projected onto the road surface G from the projector 6. Note that the FIGS. 3A and 3C illustrate the arrangement position of the projector 6 and the projected light pattern P illustrated in FIG. 2A. FIGS. 3B and 3D illustrate the arrangement position of the projector 6 and the projected light pattern P illustrated in FIG. 2B. As illustrated in FIG. 3A, the projectors 6 capable of projecting a straight light pattern P are arranged in a total of four places including the front part, the left and right side parts, and the rear part of the motorcycle 1. The projector 6 arranged in the front part of the motorcycle 1 projects a straight light pattern P onto the road surface G ahead of the motorcycle 1 in parallel with a vehicle width direction of the motorcycle 1. The projectors 6 arranged in the left and right side parts of the motorcycle 1 project straight light patterns P onto the road surface G in the left and right sides, respectively, of the motorcycle 1 in parallel with the front-rear direction of the motorcycle 1. The projector 6 arranged in the rear part of the motorcycle 1 projects a straight light pattern P onto the road surface G rearward of the motorcycle 1 in parallel with the vehicle width direction of the motorcycle 1.

As illustrated in FIG. 3B, a total of four projectors 6 for projecting L-shaped light patterns P onto the road surface G are arranged in the front right part, the front left part, the rear right part, and the rear left part of the motorcycle 1. The four projectors 6 project L-shaped light patterns P indicating four corners of a rectangle onto the road surface G in the front right side, the front left side, the rear right side, and the rear left side of the motorcycle 1.

In this manner, the four projectors 6 project the light patterns P onto the road surface G around the motorcycle 1 to form outer edges of an area larger than the motorcycle 1, including the position of the motorcycle 1. According to this embodiment, using the four projectors 6, outer edges of a rectangular area are projected onto the road surface G. That is, the light patterns P of the rectangle projected onto the road surface G using the four projectors 6 indicate outer edges of the area described above. The light patterns P of the rectangle projected from the four projectors 6 indicate desirable minimum distances between the motorcycle 1 (main vehicle) and neighboring vehicles. For this reason, if any other vehicle intrudes into this area, the intruding vehicle exists in a position closer than the desirable minimum distance.

As illustrated in FIGS. 3C and 3D, the area formed by projecting light using the four projectors 6 may have a trapezoidal shape widening forward of the motorcycle 1. For example, in a configuration in which the four projectors 6 project rectangular or square light patterns P, other drivers of the vehicles behind the motorcycle 1 recognize this light pattern P as a trapezoidal shape tapered forward. For this reason, visibility of the projected light pattern P is degraded. In this regard, if the shape of this area is set to a trapezoidal shape widening forward of the motorcycle 1 as illustrated in FIGS. 3C and 3D, other drivers of vehicles behind the motorcycle 1 recognize this light pattern P as a rectangular or square shape. For this reason, visibility of the light pattern P is improved.

By rotating the light source 60 of the projector 6 using the first to third driving mechanisms 61, 62, and 63 around the optical axis, it is possible to change the direction of the optical axis L of the light source 60. Therefore, by changing the direction or position of the light pattern P projected from each of the four projectors 6, it is possible to change the position or size of the rectangular area. Further, the four projectors 6 can be controlled independently, and the rotation or the projected position of the light pattern P can be changed individually and independently.

Here, an exemplary arrangement position of the projector 6 will be described. The projector 6 that projects a straight light pattern P onto the road surface G forward of the motorcycle 1 is arranged in the front part of the front fairing 201 of the motorcycle 1, specifically, in the vicinity of the headlamp 204. In addition, the projector 6 that projects the light pattern P forward may be formed integrally with the headlamp 204, that is, may be unitized with the headlamp 204. The projectors 6 that project straight light patterns P onto the road surface G sideward of the motorcycle 1 are arranged in the side fairing 202 or the rear fairing 203. In particular, they are arranged such that the emitted light is not blocked by a human body of the driver. The projector 6 that projects a straight light pattern P onto the road surface G rearward of the motorcycle 1 is installed in the tail light 205, the rear fender 143, or the like. Furthermore, the projector 6 that projects a straight light pattern P onto the road surface G rearward of the motorcycle 1 may be formed integrally with the tail lamp 205, that is, may be unitized with the tail lamp 205.

A pair of projectors 6 that project the L-shaped light patterns P toward the front right side and the front left side of the motorcycle 1 are arranged in the front right part and the front left part, respectively, of the front fairing 201, in the front direction indicators 206, in the left and right rearview mirrors 306, or the like. For example, these projectors 6 may be unitized with the direction indicators 206 or the rearview mirrors 306. The projectors 6 that project the L-shaped light patterns P toward the rear right side and the rear left side of the motorcycle 1 are arranged in the rear direction indicators 206 or the like. These projectors 6 may be unitized with the rear direction indicators 206.

Further, the specific arrangement positions of the projectors 6 are not particularly limited. Similarly, the number of the projectors 6 is not limited to four. In short, as illustrated in FIGS. 3A and 3B, a plurality of projectors 6 may be arranged such that rectangular light patterns P having a rectangular shape or a trapezoidal shape indicating desirable minimum distances from neighboring vehicles are projected onto the road surface G around the motorcycle 1. However, the projectors 6 are preferably arranged in higher positions in a height direction of the motorcycle 1 such that the light patterns P can be projected to a farther position from the motorcycle 1. For example, as described above, the projector 6 may be provided in the rearview mirror 306. In addition, the projectors 6 that project the light patterns 6 onto the road surface G sideward of the motorcycle 1 are preferably arranged in the vicinity of the center in the front-rear direction of the motorcycle 1.

### <Exemplary Configuration of Conspicuity/Signaling System>

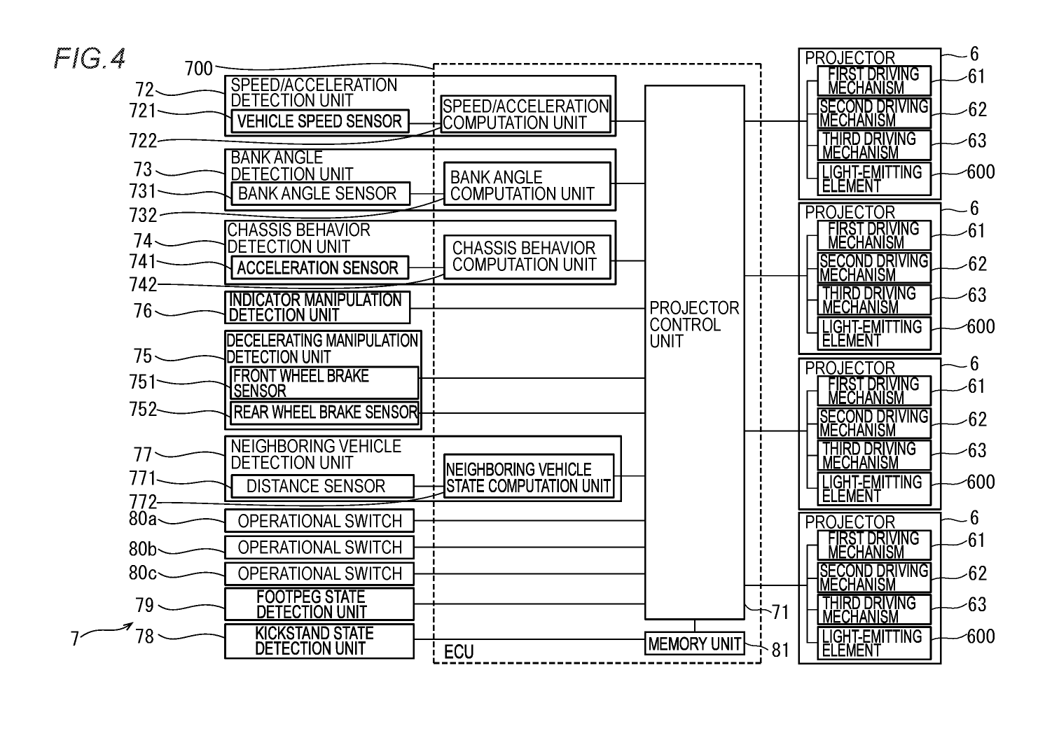

Next, an exemplary configuration of the conspicuity/signaling system 7 will be described with reference to FIG. 4. FIG. 4 is a block diagram illustrating an exemplary configuration of the conspicuity/signaling system 7. As illustrated in FIG. 4, the conspicuity/signaling system 7 includes a plurality of projectors 6 (four projectors in this embodiment) as described above, a predetermined detection unit, a memory unit 81, a projector control unit 71, and operational switches 80a to 80c. The predetermined detection unit includes a detection unit for detecting a travel state of the motorcycle 1 (main vehicle), a detection unit for detecting a manipulation for the motorcycle 1, and a detection unit for detecting presence of other vehicles or travel states of other vehicles. The detection unit for detecting a travel state of the motorcycle 1 includes a speed/acceleration detection unit 72, a bank angle detection unit 73, a chassis behavior detection unit 74, a kickstand state detection unit 78, and a footpeg state detection unit 79. The detection unit for detecting a manipulation for the motorcycle 1 includes a decelerating manipulation detection unit 75 and an indicator manipulation detection unit 76. The detection unit for detecting presence or travel states of other vehicles includes a neighboring vehicle detection unit 77.

The speed/acceleration detection unit 72 detects (computes) a vehicle speed (travel speed) and an acceleration of the motorcycle 1 and outputs the detection result (computation result) to the projector control unit 71. The speed/acceleration detection unit 72 has a vehicle speed sensor 721 and a speed/acceleration computation unit 722. The vehicle speed sensor 721 is formed, for example, using a rotation sensor configured to detect rotation of the front wheel 122. The speed/acceleration computation unit 722 obtains an output (detection result) of the vehicle speed sensor 721 and computes a vehicle speed and an acceleration of the motorcycle 1 using this output. If the vehicle speed sensor 721 is a rotation sensor capable of detecting rotation of the front wheel 122 of the motorcycle 1, the speed/acceleration computation unit 722 computes a vehicle speed of the motorcycle 1 from the rotation number (rotation speed) of the front wheel 122 detected by the vehicle speed sensor 721. In addition, the acceleration is computed by differentiating the computed vehicle speed with respect to time. The speed/acceleration detection unit 72 continuously executes detection (computation) of the vehicle speed and the acceleration and output of the detection result (computation result) to the projector control unit 71 during the activation of the conspicuity/signaling system 7 (for example, while an ECU 700 described below is activated).

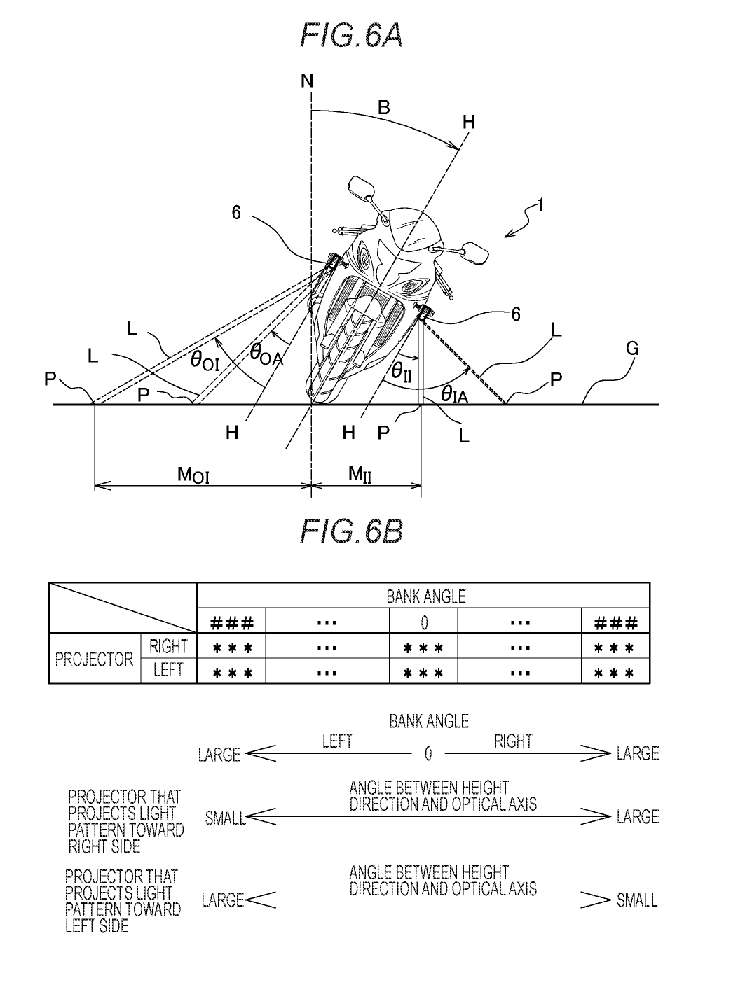

The bank angle detection unit 73 detects (computes) a bank angle B of the motorcycle 1 and outputs the detection result (computation result) to the projector control unit 71. The bank angle detection unit 73 has a bank angle sensor 731 and a bank angle computation unit 732. The bank angle sensor 731 is formed using an angular velocity sensor such as a piezoelectric oscillation gyroscopic sensor. In this case, the angular velocity sensor as the bank angle sensor 731 detects a velocity in the bank direction of the motorcycle 1. Note that the bank direction refers to a rotational direction obtained by setting contact points between the front and rear wheels 122 and 142 and the ground surface as a rotation center as seen from the front or rear side of the motorcycle 1. In addition, the bank angle B refers to an angle between a normal line N on the road surface G and a straight line H parallel with the height direction of the motorcycle 1 (refer to FIG. 6A). The bank angle computation unit 732 computes the bank angle B of the motorcycle 1 on the basis of the output of the bank angle sensor 731, that is, the angular velocity of the motorcycle 1 in the bank angle direction. The bank angle B is computed on the basis of the following formula represented as Equation (1) as described below:

B=∫w(t)dt+B₀ [Equation 1]

where “t” denotes time, “w(t)” denotes an angular velocity in the bank angle direction, and “B₀” denotes an initial value of the bank angle.

The bank angle detection unit 73 continuously executes detection (computation) of the bank angle B and output of the detection result (computation result) to the projector control unit 71 during the activation of the conspicuity/signaling system 7.

The chassis behavior detection unit 74 detects (computes) a behavior of the motorcycle 1 and outputs the detection result (computation result) to the projector control unit 71. According to this embodiment, as an index for describing the behavior of the motorcycle 1, temporal variations (time derivatives) of the accelerations along triaxial directions of the motorcycle 1 are employed. The chassis behavior detection unit 74 includes an acceleration sensor 741 and a chassis behavior computation unit 742. Triaxial directions include a front-rear direction (travel direction), a left-right direction (vehicle width direction), and a vertical direction (height direction) of the motorcycle 1. As the acceleration sensor 741, a triaxial acceleration sensor is employed to detect accelerations along the triaxial directions described above. For example, the acceleration sensor 741 is installed in the chassis 110 of the motorcycle 1. The chassis behavior computation unit 742 obtains the detection result of accelerations of each axial direction from the acceleration sensor 741 and differentiates the accelerations of each axial direction to detect (compute) the behavior of the motorcycle 1. The chassis behavior detection unit 74 continuously executes detection (computation) of the chassis behavior and output of the detection result (computation result) to the projector control unit 71 during the activation of the conspicuity/signaling system 7.

The decelerating manipulation detection unit 75 detects a manipulation for decelerating the motorcycle 1 (decelerating manipulation) from a rider. According to this embodiment, the decelerating manipulation includes each manipulation of the front wheel brake lever 302 and a rear wheel brake lever 304. For this reason, the decelerating manipulation detection unit 75 has a front wheel brake sensor 751 configured to detect a manipulation of the front wheel brake lever 302 and a rear wheel brake sensor 752 configured to detect a manipulation of the rear wheel brake lever 304. Each of the front wheel brake sensor 751 and the rear wheel brake sensor 752 has a switch capable of switching the circuit between open and close states (ON/OFF) in response to the motions of the front wheel brake lever 302 and the rear wheel brake lever 304. In this case, the projector control unit 71 detects an open/close (ON/OFF) state of the circuit of the switch provided in the front wheel brake sensor 751 and the rear wheel brake sensor 752. As a result, the projector control unit 71 can determine whether or not each of the front wheel brake lever 302 and the rear wheel brake lever 304 is manipulated, that is, whether or not the decelerating manipulation is performed.

The indicator manipulation detection unit 76 detects a manipulation of the direction indicator 206. For example, the indicator manipulation detection unit 76 has a switch capable of switching an open/close (ON/OFF) state of the circuit in response to the motion of the control lever of the direction indicator 206. In this case, the projector control unit 71 detects an open/close (ON/OFF) state of the circuit of the switch as the indicator manipulation detection unit 76. As a result, the projector control unit 71 can determine whether the control lever of the direction indicator 206 is placed in a right turn position, a left turn position, or none of the left and right turn positions.

The neighboring vehicle detection unit 77 is capable of detecting a distance between the motorcycle 1 (main vehicle) and a neighboring vehicle, a relative velocity between the motorcycle 1 and the neighboring vehicle, and presence of other vehicles trying to overtake the motorcycle 1. The neighboring vehicle detection unit 77 includes, for example, a distance sensor 771 and a neighboring vehicle state computation unit 772. As the distance sensor 771, any one of various non-contact distance sensors such as a laser distance sensor is employed. Note that, according to this embodiment, a plurality of distance sensors 771 are arranged in the motorcycle 1 in order to detect distances from other vehicles neighboring in the front side, the rear side, and the lateral sides. For example, the distance sensor 771 for detecting a distance from a vehicle neighboring in the front side of the motorcycle 1 is arranged in the front part of the front fairing 201. The distance sensor 771 for detecting a distance from a vehicle neighboring in the rear side of the motorcycle 1 is arranged in the tail light 205 or the vicinity thereof. The distance sensor 771 for detecting a distance from a vehicle neighboring in the lateral side of the motorcycle 1 is arranged in the side fairing 202 or the rear fairing 203. The detection result of the distance sensor 771 is output to the neighboring vehicle state computation unit 772.

The neighboring vehicle state computation unit 772 of the neighboring vehicle detection unit 77 computes each distance from other vehicles neighboring in the front, rear, and lateral sides of the motorcycle 1 on the basis of the detection result of the distance sensors 771. In addition, the neighboring vehicle state computation unit 772 obtains a relative velocity between the motorcycle 1 and a neighboring vehicle by computing a time derivative of the obtained distance. In addition, the neighboring vehicle state computation unit 772 determines whether or not a vehicle following the motorcycle 1 tries to overtake the motorcycle 1. Specifically, the neighboring vehicle state computation unit 772 determines that a vehicle tries to overtake the motorcycle 1 when the vehicle runs diagonally behind the motorcycle 1 and approaches the motorcycle 1.

The neighboring vehicle detection unit 77 executes detection (computation) of the distance and the relative velocity between the motorcycle 1 and a neighboring vehicle, detection (determination) of presence of other vehicles trying to overtake the motorcycle 1, and output of these detection results (computation results) to the projector control unit 71. In addition, the neighboring vehicle detection unit 77 continuously executes a series of these processes during the activation of the conspicuity/signaling system 7. Note that the determination regarding whether or not there is a vehicle trying to overtake the motorcycle 1 (detection of presence of other vehicles trying to overtake) may be performed using the projector control unit 71.

Alternatively, an imaging device (such as a camera) may be employed as the distance sensor 771. In this case, the neighboring vehicle state computation unit 772 executes image recognition for the image taken by the imaging device as the distance sensor 771 to recognize presence of other vehicles neighboring to the motorcycle 1 and compute the distance and the relative velocity from the recognized neighboring vehicle.

The operational switches 80a to 80c are switches capable of switching between ON and OFF for the operation of the projector 6. The operational switches 80a to 80c include the operational switch 80a manipulated by a rider and operational switches 80b and 80c capable of switching the ON/OFF state in response to a state of a predetermined member of the motorcycle 1.

The operational switch 80a manipulated by a rider is arranged, for example, in the handle 301, the instrument unit, or the vicinity thereof. As a rider manipulates this operational switch 80a, it is possible to switch the ON/OFF state of the operation (that is, lighting) of the light source 60 of the projector 6. Therefore, a rider can switch the ON/OFF state of projection of the light pattern P using the projector 6 on the basis a rider's intention.

The operational switches 80b and 80c switching between ON and OFF in response to a motion of a predetermined member of the motorcycle 1 includes an operational switch 80b switching between ON and OFF depending on a state of the kickstand 305 and an operational switch 80c switching between ON and OFF depending on a state of the footpeg 303. The operational switch 80b switching between ON and OFF depending on a state of the kickstand 305 is set to ON when the kickstand 305 is not used. The operational switch 80b is set to OFF when the kickstand 305 is used. When the operational switch 80b is set to OFF, the projector control unit 71 determines that the motorcycle 1 is being parked and performs control for turning off the light-emitting element 600 of the light source 60 of the projector 6. The operational switch 80c switching between ON and OFF depending on a state of the footpeg 303 is set to ON, for example, when the footpeg 303 is not rebounded. The operational switch 80c is set to OFF when the footpeg 303 is rebounded. The footpeg 303 is rebounded generally when the bank angle B is excessive, and a tip of the footpeg 303 collides with the road surface G. In this regard, when the operational switch 80c is set to OFF, the projector control unit 71 determines that the bank angle B of the motorcycle 1 is excessive, and the motorcycle 1 falls. In this case, the light-emitting element 600 of the light source 60 of the projector 6 is turned off. As a result, it is possible to prevent the light from being illuminated from the light source 60 of the projector 6 toward a direction different from that of the light pattern P to be projected onto the road surface G.

In this manner, the projector control unit 71 turns off (does not turn on) the light-emitting element 600 of the light source 60 of the projector 6 when the operational switches 80a to 80c are set to OFF. Meanwhile, when the operational switches 80a to 80c are set to ON, the projector control unit 71 operates the projector 6 depending on the detection results of each detection unit as described below. Note that any one of various circuit switches known in the art may be employed as the operational switches 80a to 80c as long as it can detect an ON/OFF state (circuit open/close state) using the projector control unit 71.

The memory unit 81 stores, in advance, various tables used when the projector control unit 71 controls the projectors 6. The tables stored in the memory unit 81 will be described later in more detail.

The projector control unit 71 controls each of the projectors 6 on the basis of the detection results from the speed/acceleration detection unit 72, the bank angle detection unit 73, the chassis behavior detection unit 74, the decelerating manipulation detection unit 75, and the indicator manipulation detection unit 76 and the tables stored in the memory unit 81. Further, the projector control unit 71 may control the plurality of projectors 6 individually and independently.

Here, an exemplary hardware configuration of the conspicuity/signaling system 7 will be described. The conspicuity/signaling system 7 has an electronic control unit (ECU) 700. In addition, the ECU 700 is connected to the vehicle speed sensor 721, the bank angle sensor 731, the acceleration sensor 741, and the distance sensor 771, so that it can obtain outputs from these sensors. The ECU 700 is connected to a switch serving as the decelerating manipulation detection unit 75, a switch serving as the indicator manipulation detection unit 76, and the operational switches 80a to 80c. In addition, the ECU 700 can detect (determine) the ON/OFF states of these switches. Furthermore, the ECU 700 is connected to a predetermined number of projectors 6 (in this embodiment, four projectors).

The ECU 700 has a computer provided with a central processing unit (CPU), a read-only memory (ROM), and a random access memory (RAM). The ROM of the computer stores, in advance, a computer program for controlling the projectors 6 and various tables which will be described below. The CPU reads the computer program stored in the ROM and executes it by using the RAM as a work area. In this case, the CPU references various tables stored in the ROM. As a result, the computer of the ECU 700 serves as the projector control unit 71, the speed/acceleration detection unit 72, the bank angle detection unit 73, the neighboring vehicle detection unit 77, and the memory unit 81 so that the operations described below are implemented.

### <Operations of Conspicuity/Signaling System>

Next, operations of the conspicuity/signaling system 7 will be described by way of example. As a basic operation during the activation of the conspicuity/signaling system 7 (for example, while the ECU 700 is activated), the projector control unit 71 controls a plurality of projectors 6 individually and independently. As illustrated in FIGS. 3A to 3D, the light patterns P indicating outer edges of the area larger than the motorcycle 1 including a position of the motorcycle 1 are projected onto the road surface G. In this case, when there is no change in the travel state of the motorcycle 1, a particular manipulation for the motorcycle 1, or a relationship between the motorcycle 1 and a neighboring vehicle, the projector control unit 71 performs control such that the light patterns P of FIGS. 3A to 3D are continuously projected onto the road surface G without changing the projection status of the light patterns P.

### (First Operation)

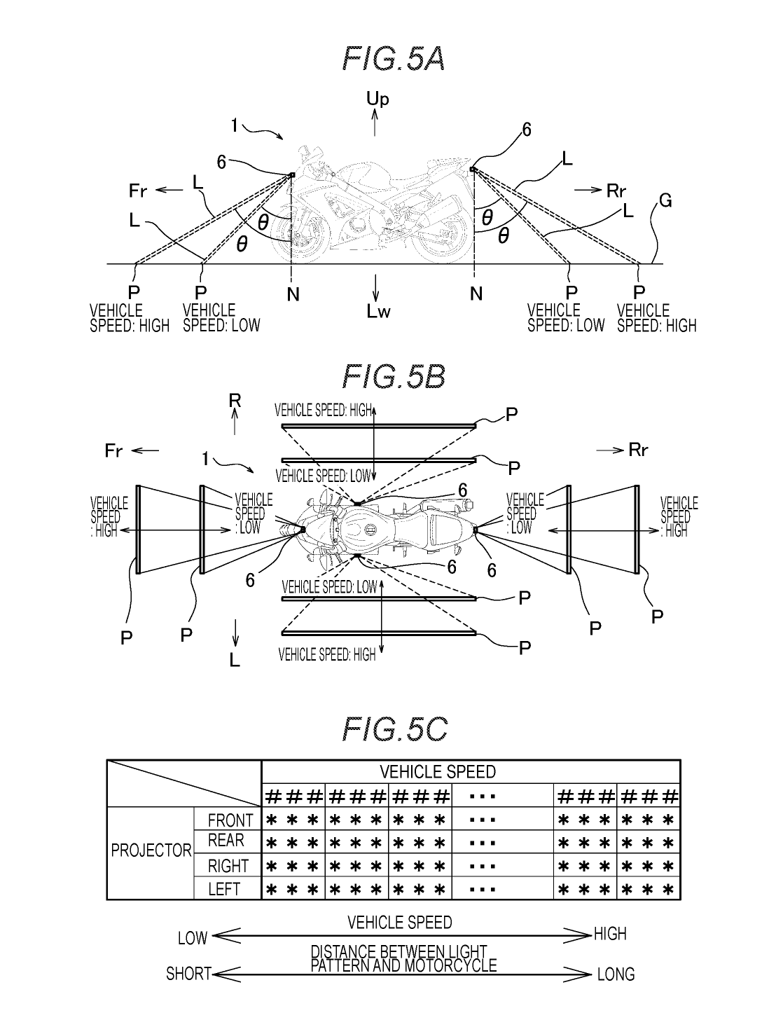

In a first operation, for example, a projection status of the light pattern P is changed depending on a travel state of the motorcycle 1. FIG. 5A is a side view schematically illustrating the first operation, FIG. 5B is a plan view schematically illustrating the first operation, and FIG. 5C is a diagram illustrating exemplary contents of the table used in the first operation. In the first operation, the distance of the light pattern P projected onto the road surface G from the motorcycle 1 is changed depending on a vehicle speed of the motorcycle 1. A desirable minimum distance between the motorcycle 1 and other vehicles is different depending on the vehicle speed of the motorcycle 1. In particular, the desirable minimum distance increases as the vehicle speed increases. In this regard, in the first operation, the distance of the light pattern P projected onto the road surface G from the motorcycle 1 is changed depending on the vehicle speed. In particular, the distance of the light pattern P projected onto the road surface G from the motorcycle 1 decreases as the vehicle speed decreases. In addition, the distance of the light pattern P increases as the vehicle speed increases.

The table used in the first operation is stored in the memory unit 81 in advance. As illustrated in FIG. 5C, this table contains distances between light patterns P projected onto the road surface G and the motorcycle 1 defined for each projector 6 depending on the vehicle speed. The distance between the light pattern P projected onto the road surface G and the motorcycle 1 decreases as the vehicle speed decreases. The distance increases as the vehicle speed increases. However, specific numerical values are not particularly limited, but may be appropriately set. The projector control unit 71 obtains the detection result regarding the vehicle speed of the motorcycle 1 from the speed/acceleration detection unit 72 and applies the obtained vehicle speed of the motorcycle 1 to this table. As a result, the distance between the light pattern P projected onto the road surface G and the motorcycle 1 is determined for each projector 6. Furthermore, the projector control unit 71 controls the first to third driving mechanisms 61, 62, and 63 of each projector 6 such that the distances between the light patterns P projected onto the road surface G from each projector 6 and the motorcycle 1 match the corresponding distances defined in this table.

Alternatively, the table used in the first operation may not define the distance between the projected light pattern P and the motorcycle 1. For example, in this table, directions of the optical axes L of each projector 6 may be defined depending on the vehicle speed. In this case, the projector control unit 71 controls the first to third driving mechanisms 61, 62, and 63 of each projector 6 such that the directions of the optical axes L of the light sources 60 of each projector 6 are aligned to match the directions defined in this table. Note that the direction of the optical axis L is defined, for example, by an angle θ between the optical axis L and the normal line N of the road surface G as seen from the vehicle width direction. In addition, this table may define rotational directions and rotational angles of the light sources 60 of each projector 6 with respect to respective initial positions defined depending on the vehicle speed. In this case, the projector control unit 71 uses the rotational direction and the rotational angle determined on the basis of this table as the rotational direction and the rotational angle of the light source 60 from its initial position when the first to third driving mechanisms 61, 62, and 63 of each projector 6 are controlled.

The first operation is not limited to the table-based configuration. For example, the distance between the projected light pattern P and the motorcycle 1 may be computed on the basis of a vehicle speed. In this case, the ROM stores a computation formula for computing the distances between the motorcycle 1 and the light patterns P projected from each projector 6 on the basis of the vehicle speed in advance. The projector control unit 71 computes the distance between the motorcycle 1 and the light pattern P projected from each projector 6 by substituting the vehicle speed detected by the speed/acceleration detection unit 72 with this computation formula. In addition, the projector control unit 71 controls the first to third driving mechanisms 61, 62, and 63 of each projector 6 such that the distance between the motorcycle 1 and the light pattern P projected from each projector 6 matches the distance obtained using the computation formula.

### (Second Operation)

A second operation is an exemplary operation for changing a projection status of the light pattern P depending on a travel state of the motorcycle 1. FIG. 6A is a plan view schematically illustrating the second operation, and FIG. 6B is a diagram illustrating exemplary contents of the table used in the second operation. In the second operation, the projection direction of the light pattern P is changed depending on a bank angle B of the motorcycle 1. In other words, a position where the light pattern P is projected is corrected depending on a bank angle B of the motorcycle 1. As illustrated in FIG. 6A, for the projectors 6 that project the light patterns P onto the road surface G in the lateral sides of the vehicle width direction of the motorcycle 1, it is assumed that absolute values of the angles θ_{II} and θ_{OI} between the projection direction of the light pattern P (that is, the optical axis L) and the straight line H parallel with the height direction are equal between the left and right sides. In this case, as the motorcycle 1 is banked, a distance M_{II} inward of the bank between the motorcycle 1 and the light pattern P projected onto the road surface G (here, the distance from the vehicle width center) decreases, and a distance M_{OI} outward of the bank between the motorcycle 1 and the light pattern P projected onto the road surface G increases. In this manner, when the motorcycle 1 is banked, the distances between the motorcycle 1 and the light patterns P projected onto the road surface G in the lateral sides of the motorcycle 1 are changed. Furthermore, the distances M_{II} and M_{OI} inward and outward of the bank between the motorcycle 1 and the light patterns P are different from each other. For this reason, it may fail to accurately indicate the desirable minimum distance from other vehicles.

In the second operation, for the projector 6 placed inward of the bank, an angle θ_{IA} between the projection direction (optical axis L) of the light pattern P and the straight line H parallel with the height direction as seen in the front-rear direction of the motorcycle 1 is set to be larger than the angle θ_{II} of no bank. Meanwhile, for the projector 6 placed outward of the bank, an angle θ_{OA} between the projection direction of the light pattern P (optical axis L) and the straight line H parallel with the height direction as seen in the front-rear direction of the motorcycle 1 is set to be smaller than the angle θ_{OI} of not bank. As a result, when the motorcycle 1 is banked, it is possible to suppress a change of the distance between the motorcycle 1 and the projected light pattern P and accurately indicate the desirable minimum distance from other vehicles.

The table used in the second operation is stored in the memory unit 81 in advance. As illustrated in FIG. 6B, the table used in the second operation contains the projection directions of the light patterns P of each projector 6 defined depending on the bank angle B. Note that the projection directions of the light patterns P are defined, for example, as the angles θ_{IA} and θ_{OA} between the optical axes L of the projectors 6 and the straight line H parallel with the height direction as seen in the front-rear direction of the motorcycle 1. In this table, if the projector 6 is placed inward of the bank, this angle θ_{IA} is defined to increase as the bank angle B increases. Meanwhile, if the projector 6 is placed outward of the bank, this angle θ_{OA} is defined to decrease as the bank angle B increases. However, the numerical values may be appropriately set depending on the specification of the motorcycle 1, the arrangement position of the projector 6, and the like without a particular limitation.

The projector control unit 71 obtains the detection result (computation result) of the bank angle B of the motorcycle 1 from the bank angle detection unit 73 and applies the obtained bank angle B to this table. As a result, for the projectors 6 that project the light patterns P onto the road surface G in the lateral sides of the vehicle width direction, the projection directions of the light patterns P are determined. In addition, the projector control unit 71 controls the first to third driving mechanisms 61, 62, and 63 of each projector 6 such that the projection directions of the light patterns P of each projector 6 are aligned to match the directions determined on the basis of the table.

In addition, if the bank angle B is equal to or larger than a threshold value, the projector control unit 71 determines that the motorcycle 1 falls. Therefore, the light-emitting element 600 of the light source 60 of the projector 6 is turned off. Specifically, the threshold value may be set to 70°, but not limited thereto. In this operation, when the motorcycle 1 falls, it is possible to prevent the light pattern P from being projected to an inappropriate position different from the determined position.

Note that the second operation is not limited to the table-based configuration. For example, the projection direction of the light pattern P may be computed on the basis of the detected bank angle B. In this case, the ROM stores a computation formula for computing the projection direction of the light pattern P of each projector 6 depending on the bank angle B and the bank direction. The projector control unit 71 computes the projection direction of the light pattern P for each projector 6 by substituting the bank angle B detected by the bank angle detection unit 73 with this computation formula. In addition, the projector control unit 71 controls the first to third driving mechanisms 61, 62, and 63 of each projector 6 such that the projection direction of the light pattern P of each projector 6 is aligned to match the direction computed on the basis of the computation formula.

### (Third Operation)

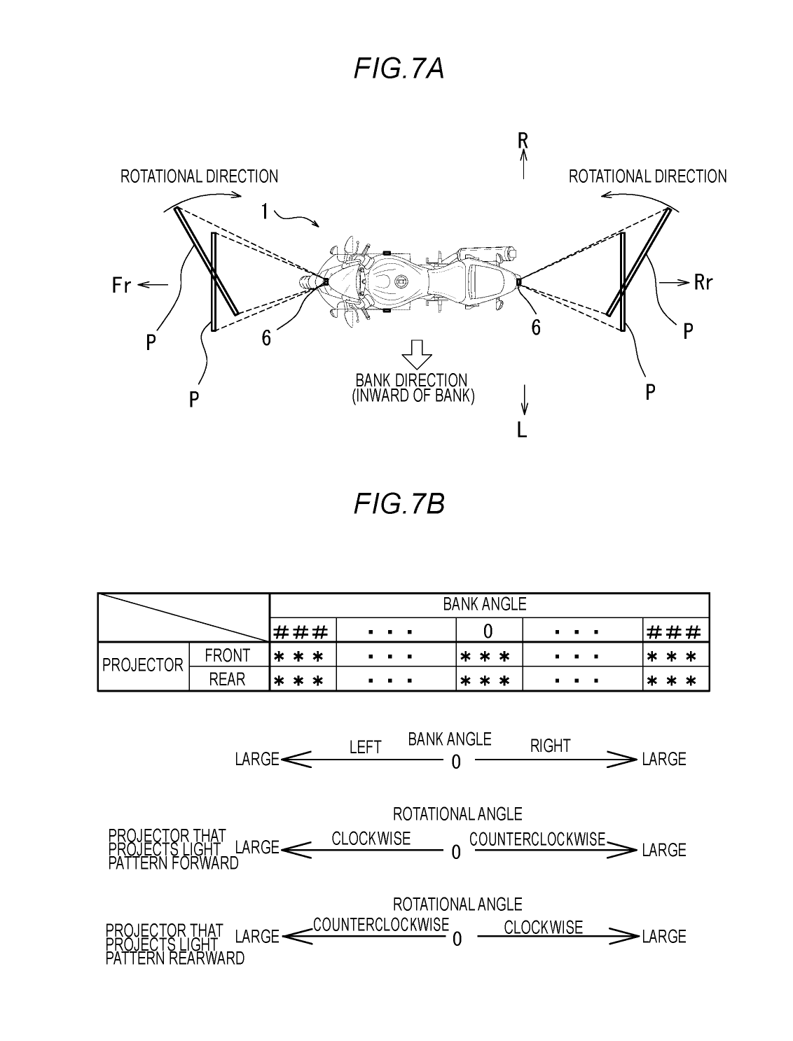

The third operation is an exemplary operation for changing a projection status of the light pattern P depending on a travel state of the motorcycle 1. FIG. 7A is a plan view schematically illustrating the third operation, and FIG. 7B is a diagram exemplarily illustrating contents of the table used in the third operation. In the third operation, the rotational angle of the light pattern P projected onto the road surface G is changed depending on the bank angle B of the motorcycle 1. When the motorcycle 1 is banked, the distance between the road surface G and the projectors 6 that project the light patterns P forward and rearward of the motorcycle 1 decreases inward of the bank and increases outward of the bank. For this reason, if it is difficult to rotate the light pattern P projected onto the road surface G around the optical axis, the light patterns P projected onto the road surface G forward and rearward of the motorcycle 1 become close to the motorcycle 1 inward of the bank and become distant outward of the bank as illustrated in FIG. 7A. Specifically, assuming that a straight light pattern P is projected, the straight light pattern P is sloped in the vehicle width direction. For this reason, a rectangular area is deformed, so that it is difficult to accurately indicate the desirable minimum distance from other vehicles.

In this regard, in the third operation, when the motorcycle 1 is banked, the projectors 6 that project the light patterns P onto the road surface G forward and rearward of the motorcycle 1 are configured such that the projected light pattern P is rotated around its optical axis. As a result, even when the motorcycle 1 is banked, it is possible to prevent deformation of the shape of the rectangular area and accurately indicate the desirable minimum distance from other vehicles.

The table used in the third operation is stored in the memory unit 81 in advance. As illustrated in FIG. 7B, this table contains the rotational direction and the rotational angle around the optical axis of the light pattern P projected onto the road surface G defined depending on the bank angle B and the bank direction for the projectors 6 that project the light patterns P onto the road surface G forward and rearward of the motorcycle 1. For example, this table contains the rotational directions from an initial angle defined depending on the bank angle B by setting a predetermined rotational angle of the light source 60 as the initial angle. As the initial angle, a rotational angle of the light source 60 in a straightly running state of the motorcycle, that is, a rotational angle at which the light pattern P parallel with the vehicle width direction can be projected when the bank angle B is set to zero may be employed.

Referring to this table, when the motorcycle 1 is banked to the left, the projected light pattern P is defined to be rotated clockwise in the case of the projector 6 that projects the light pattern P onto the road surface G forward of the motorcycle 1. Meanwhile, in the case of the projector 6 that projects the light pattern P onto the road surface G rearward of the motorcycle 1, the projected light pattern P is defined to be rotated counterclockwise. In contrast, when the motorcycle 1 is banked to the left, the projected light pattern P is defined to be rotated counterclockwise in the case of the projector 6 that projects the light pattern P onto the road surface G forward of the motorcycle 1. Meanwhile, in the case of the projector 6 that projects the light pattern P onto the road surface G rearward of the motorcycle 1, the projected light pattern P is defined to be rotated clockwise. In either case, the rotational angle is defined to increase as the bank angle B increases.

The projector control unit 71 obtains the detection result (computation result) regarding the bank angle B and the bank direction of the motorcycle 1 from the bank angle detection unit 73 and applies the obtained bank angle and direction to the table of FIG. 7B. As a result, the rotational angles and the rotational directions of the light patterns P projected onto the road surface G from each projector 6 are determined. In addition, the projector control unit 71 controls the first driving mechanism 61 of each projector 6 such that the light pattern P projected onto the road surface G is rotated by rotating the light source 60 around its optical axis.

As a result, it is possible to align the light patterns P projected forward and rearward of the motorcycle 1 in parallel with the vehicle width direction of the motorcycle 1. Therefore, even when the motorcycle 1 is banked, it is possible to accurately indicate the desirable minimum distance from other vehicles.

Note that the third operation is not limited to the table-based configuration. For example, the rotational direction and the rotational angle of the light pattern P may be computed on the basis of the detection result regarding the bank angle B and the bank direction from the bank angle detection unit 73. In this case, the ROM stores a computation formula for computing the rotational directions and the rotational angles of the light patterns P of each projector 6 on the basis of the bank angle B and the bank direction. The projector control unit 71 computes the rotational direction and the rotational angle of the light pattern P projected from each projector 6 by substituting the bank angle B and the bank direction detected by the bank angle detection unit 73 with this computation formula. In addition, the projector control unit 71 controls the first driving mechanism 61 of each projector 6 such that the rotational direction and the rotational angle of the light pattern P projected from each projector 6 match the rotational direction and the rotational angle computed using the computation formula.

### (Fourth Operation)

The fourth operation is an exemplary operation for changing the projection status of the light pattern P depending on a travel state of the motorcycle 1. In the fourth operation, the projection of the light pattern P from the projector 6 is switched between ON and OFF depending on a behavior of the motorcycle 1. When the motorcycle 1 severely vibrates or abruptly rolls to the left or right, the operation of changing the projection position of the light pattern P using the first to third driving mechanisms 61, 62, and 63 may not catch up with such abrupt vibration or rolling. In this case, the position of the light pattern P projected onto the road surface G from the projector 6 may abruptly vary, and the light pattern P may be erroneously projected onto a position different from a desired position. In this manner, if the behavior of the motorcycle 1 abruptly varies, it may be difficult to achieve its original purpose of the light pattern P projected onto the road surface G. In the fourth operation for preventing such a problem, when the behavior of the motorcycle 1 becomes unstable, the projection of the light pattern P onto the road surface G from the projector 6 stops.

When the motorcycle 1 severely vibrates or abruptly rolls, a temporal variation of the acceleration applied to the motorcycle 1 (a time derivative of the acceleration) increases. In this regard, in the fourth operation, the temporal variation of the acceleration of the motorcycle 1 is used as an index of the behavior of the motorcycle 1. Specifically, as the temporal variation of the acceleration applied to the motorcycle 1 decreases, the behavior of the motorcycle 1 is considered as being stable (most stable in zero). As the temporal variation of the acceleration increases, instability of the behavior is considered as being increasing. In addition, when the temporal variation of the acceleration is equal to or greater than the threshold value, the projection of the light pattern P onto the road surface G from the projector 6 stops.

The chassis behavior computation unit 742 of the chassis behavior detection unit 74 obtains the output of the acceleration sensor 741 (triaxial accelerations) and computes a temporal variation (time derivatives) of the obtained acceleration. The projector control unit 71 determines whether the temporal variation of the triaxial acceleration obtained from the chassis behavior detection unit 74 is equal to or larger than a predetermined threshold value or whether it is smaller than the threshold value. The threshold value is appropriately set without limiting to a particular value. In addition, if the temporal variation of any one of the triaxial accelerations is equal to or larger than the threshold value, the projector control unit 71 determines that the chassis behavior is unstable, so that the projection of the light pattern P stops by turning off the light-emitting element 600. In contrast, if the temporal variation is smaller than the threshold value, the projector control unit 71 performs control such that the light pattern P is continuously projected from the projector 6 without turning off the light-emitting element 600. Furthermore, the projector control unit 71 resumes the projection of the light pattern P by turning on the light-emitting element 600 if the temporal variation of the acceleration become smaller than the threshold value again after the stop of projection of the light pattern P from the projector 6.

### (Fifth Operation)

In the fifth operation, for example, an operation of changing the projection status of the light pattern P in response to a manipulation for the motorcycle 1 and an operation of changing the projection status of the light pattern P depending on a travel state of the motorcycle 1 are combined. In the fifth operation, in at least one of the case where a rider makes a decelerating manipulation and the case where the motorcycle 1 is decelerated, the projection status of the light pattern P projected onto the road surface G rearward of the motorcycle 1 is changed. When the motorcycle 1 is decelerated, other vehicles following the motorcycle 1 may approach the motorcycle, and a distance between the motorcycle 1 and the rear vehicle may become shorter than the desirable minimum distance. In this regard, when the motorcycle 1 is decelerated, other drivers behind the motorcycle 1 are cautioned by changing the projection status of the light pattern P projected onto the road surface G rearward of the motorcycle 1.

The projector control unit 71 continuously performs the following operations (1) and (2) during the operation of the conspicuity/signaling system 7. (1) It is determined whether or not a decelerating manipulation (in this embodiment, braking manipulation) is made on the basis of the detection result of the decelerating manipulation detection unit 75. (2) The detection result of the acceleration of the motorcycle 1 is obtained from the speed/acceleration detection unit 72, and it is determined whether or not the acceleration is a negative value and whether an absolute value of the acceleration is equal to or greater than a predetermined threshold value. Note that the threshold value is appropriately set without a particular limitation.

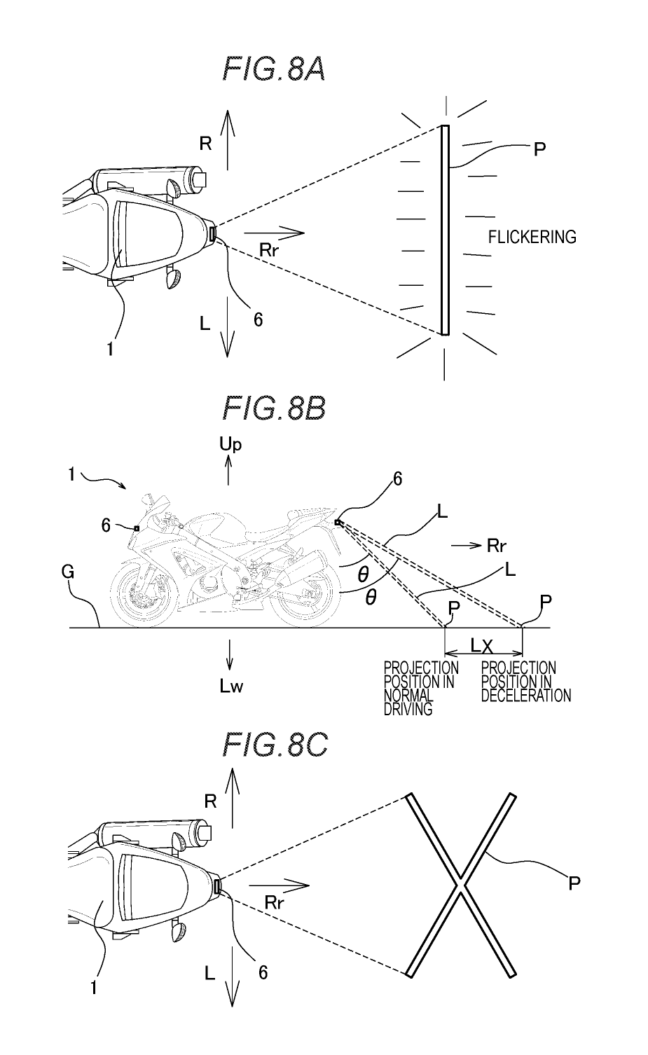

FIGS. 8A to 8C are plan views schematically illustrating the fifth operation. The projector control unit 71 performs control such that the projection status of the light pattern P projected onto the road surface G rearward of the motorcycle 1 is changed in at least one of the case where it is determined that a decelerating manipulation is made and the case where the acceleration is a negative value, and an absolute value of the acceleration is greater than a threshold value. For example, as illustrated in FIG. 8A, the projector control unit 71 performs control such that the light-emitting element 600 of the light source 60 of the projector 6 that projects the light pattern P onto the road surface G rearward of the motorcycle 1 is flickered. As a result, the light pattern P projected onto the road surface G rearward of the motorcycle 1 is flickered. Alternatively, as illustrated in FIG. 8B, the light pattern P projected onto the road surface G rearward of the motorcycle 1 is shifted backward relative to a normal projection position. A backward shift length Lx of the light pattern P may be set, for example, such that the projection position is shifted backward as the vehicle speed V of the motorcycle 1 increases, or the shift length Lx may be set as a product between the vehicle speed V at that time point and the vehicle deceleration g. In the latter case, if the motorcycle 1 is driven at a high speed (high velocity V), the length Lx increases, and the projection position is shifted backward. If the motorcycle 1 is driven at a low speed, but is abruptly decelerated (high deceleration g), the length Lx increases, and the projection position is shifted backward similarly. In addition, a projector 6 capable of projecting an X-shaped light pattern P is disposed in the rear part of the motorcycle 1 as illustrated in FIG. 8C. The projector control unit 71 controls this projector 6 such that the X-shaped light pattern P is projected onto the road surface G rearward of the motorcycle 1. In this operation, it is possible to caution other drivers behind the motorcycle 1.

### (Sixth Operation)

The sixth operation is an exemplary operation for changing the projection status of the light pattern P depending on a manipulation for the motorcycle 1. In the sixth operation, when a travel route is changed, other drivers of vehicles neighboring to the motorcycle 1 are informed of this change of the travel route. Here, the travel route change includes right turn, left turn, U-turn, lane change, and the like. During the activation of the conspicuity/signaling system 7, the projector control unit 71 continuously executes the following two operations (1) and (2). (1) The detection result is obtained from the indicator manipulation detection unit 76, and it is determined whether the direction indicator 206 indicates right turn, left turn, or none of the right and left turns. (2) The detection result for the acceleration in the vehicle width direction is obtained from the chassis behavior detection unit 74, and a turning direction of the motorcycle 1 is determined on the basis of the acceleration direction in the vehicle width direction of the motorcycle 1. In addition, it is determined whether or not the acceleration is equal to or higher than a predetermined threshold value.

When the direction indicator 206 is manipulated, the projector control unit 71 determines whether the manipulation is for right turn or left turn on the basis of the detection result from the indicator manipulation detection unit 76. In addition, if the acceleration in the vehicle width direction is higher than a threshold value, the projector control unit 71 determines that the travel route is being changed. In this case, the projector control unit 71 determines whether the travel route is changed to the right or the left on the basis of the acceleration direction. In addition, if it is determined that the direction indicator 206 is manipulated for right or left turn, or if the acceleration in the vehicle width direction is equal to or higher than the threshold value, the projector control unit 71 determines that the travel route will be changed or determines that the travel route is being changed. In addition, the projector control unit 71 changes the projection status of the light pattern P projected onto the road surface G rearward or sideward of the motorcycle 1 depending on the direction of the travel route change. Further, if the detection result from the indicator manipulation detection unit 76 and the detection result from the chassis behavior detection unit 74 do not match each other, a priority may be given to any one of the detection results.

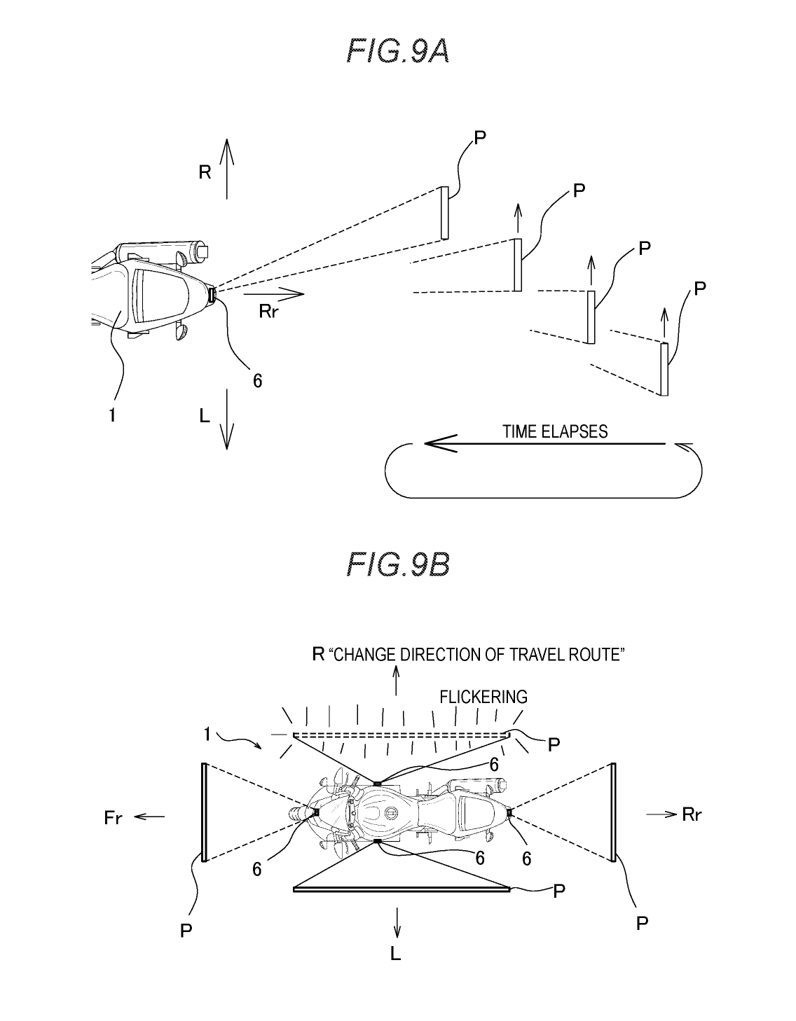

FIGS. 9A and 9B are plan views schematically illustrating the sixth operation. As illustrated in FIG. 9A, the projector 6 that projects the light pattern P onto the road surface G rearward of the motorcycle 1 changes the light pattern P such that the light flows along the travel direction (the change direction of the travel route). That is, as illustrated in FIG. 9A, if the travel route is changed to the right, the projector control unit 71 changes the light pattern P such that the light flows from the left to the right. If the travel route is changed to the left, the light pattern P is changed such that the light flows from the right to the left. Alternatively, as illustrated in FIG. 9B, the projector 6 that projects the light pattern P onto the road surface G sideward of the motorcycle 1 flickers the light pattern P corresponding to the travel direction (the change direction of the travel route) out of the left and right. That is, as illustrated in FIG. 9B, the projector control unit 71 flickers the right light pattern P when the travel route is changed to the right. Similarly, the left light pattern P is flickered when the travel route is changed to the left.

### (Seventh Operation)

The seventh operation is an exemplary operation for changing the projection status of the light pattern P depending on a relationship between the motorcycle 1 and a neighboring vehicle. In the seventh operation, the projection status of the light pattern P projected onto the road surface G is changed when a distance between the motorcycle 1 and any one of other neighboring vehicles is equal to or shorter than a predetermined threshold value. It is preferable that the distances between the motorcycle 1 and other neighboring vehicles be equal to or longer than the desirable minimum distance. In this regard, in the seventh operation, if it is highly likely that the distance between the motorcycle 1 and other vehicles becomes shorter than the desirable minimum distance, the projection status of the light pattern P projected onto the road surface G is changed. For example, the light pattern P may be flickered, or the color of the light pattern P may be changed. As a result, it is possible to caution a rider of the motorcycle 1 or other drivers.

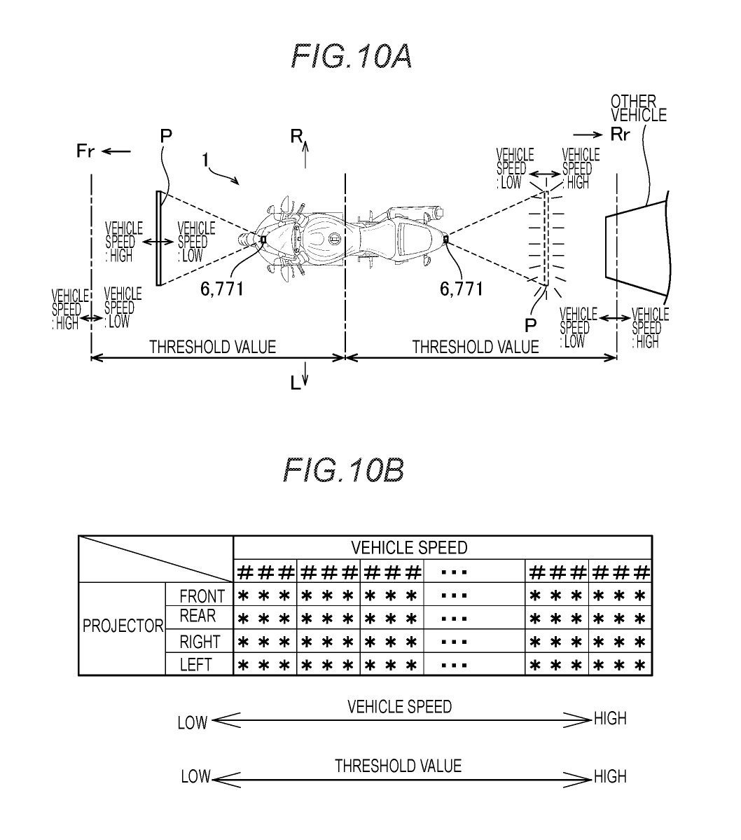

FIG. 10A is a plan view schematically illustrating the seventh operation. Here, a case where the projection status of the light pattern P projected onto the road surface G rearward of the motorcycle 1 is changed will be described. The projector control unit 71 obtains the detection result from the neighboring vehicle detection unit 77 and determines whether or not the distance between the motorcycle 1 and the vehicle following behind is equal to or shorter than a predetermined threshold value. Note that the projector control unit 71 continuously executes a series of these processes during the activation of the conspicuity/signaling system 7. In addition, the threshold value is set to a length longer than the desirable minimum distance.

If the distance from other vehicles detected from the neighboring vehicle detection unit 77 is equal to or shorter than a threshold value, the projector control unit 71 controls the light source 60 of the projector 6 that projects the light pattern P onto the road surface G rearward of the motorcycle 1 such that the projection status of the projected light pattern P is changed. For example, as illustrated in FIG. 10A, the light pattern P projected onto the road surface G rearward of the motorcycle 1 is flickered. As a result, it is possible to inform other drivers following the motorcycle 1 of a fact that they may excessively approach the motorcycle 1 within the desirable minimum distance.

Note that, although FIG. 10A illustrates an example in which the projection status of the light pattern P projected onto the road surface G rearward of the motorcycle 1 is changed, the projection status of the light pattern P projected sideward or forward of the motorcycle 1 may be changed similarly. However, the rider of the motorcycle 1 is usually informed of the operation for changing the projection status of the light pattern P projected onto the road surface G forward of the motorcycle 1. In addition, both the rider of the motorcycle 1 and other drivers neighboring in the sides of the motorcycle 1 can be informed of the operation for changing the projection status of the light pattern P projected onto the road surface G sideward of the motorcycle 1.

FIG. 10B illustrates an exemplary table used in the seventh operation. The desirable minimum distance between the motorcycle 1 and other vehicles is different depending on the vehicle speed of the motorcycle 1. For this reason, similarly, the threshold value is also different depending on the vehicle speed of the motorcycle 1. In this regard, in the seventh operation, the projector control unit 71 controls the light sources 60 of the projectors 6 using a table defining the aforementioned threshold values depending on the vehicle speed. As illustrated in FIG. 10B, the table used in the seventh operation defines the aforementioned threshold values (that is, the distance at which the change of the projection status of the light pattern P starts) for each projector 6 depending on the vehicle speed. These threshold values are defined to be greater than the desirable minimum distance. In addition, the threshold value decreases as the vehicle speed decreases. The threshold value increases as the vehicle speed increases. However, these threshold values are appropriately set without limiting to a particular numerical value.

The projector control unit 71 obtains the detection result regarding the vehicle speed of the motorcycle 1 from the speed/acceleration detection unit 72 and determines the threshold value by applying the obtained vehicle speed of the motorcycle 1 to this table. In addition, if the distance from other vehicles is equal to or shorter than the threshold value, the projector control unit 71 changes the projection status of the light pattern P projected onto the road surface G from the projector 6. Note that the projector control unit 71 stops the change of the projection status of the light pattern P if the distance from other vehicles becomes longer than the threshold value after the change of the projection status of the light pattern P starts.

Alternatively, the seventh operation may be performed without using the table of FIG. 10B. For example, the threshold value may be computed using a computation formula. In this case, the memory unit 81 stores a computation formula for computing the threshold value depending on the vehicle speed. The projector control unit 71 computes the threshold value by applying the detection result for the distance from other vehicles obtained from the neighboring vehicle detection unit 77 to this computation formula. In addition, the projector control unit 71 determines whether the distance between the motorcycle 1 and other vehicles is equal to or shorter than the computed threshold value. If the distance is equal to or shorter than the threshold value, the projector control unit 71 controls the light source 60 of the projector 6 that projects the light pattern P onto the road surface G in the corresponding direction such that the projection status of the light pattern P projected onto the road surface G is changed.

### (Eighth Operation)

The eighth operation is an exemplary operation for changing the projection status of the light pattern P depending on a combination of the travel state of the motorcycle 1 and the relationship between the motorcycle 1 and neighboring vehicles. In the eighth operation, the light-emitting element 600 of the light source 60 of the projector 6 emits weak light or turns off the light in the event of a traffic jam or the like. In the event of a traffic jam or the like, generally, the motorcycle 1 is driven at a low speed, and other vehicles are slowly driven within a short distance around the motorcycle 1. For this reason, other drivers of neighboring vehicles may be dazzled by the light pattern P projected from the projector 6 or the light emitted from the projector 6. In this regard, in the eighth operation, in the event of a traffic jam or the like, the light-emitting element 600 of the light source 60 of the projector 6 emits weak light or is turned off.

During the activation of the conspicuity/signaling system 7, the projector control unit 71 continuously executes the following operations (1) and (2). (1) The detection result regarding the vehicle speed is obtained from the speed/acceleration detection unit 72, and it is determined whether the obtained vehicle speed is equal to or lower than a predetermined threshold value. (2) The detection result regarding the distance from other vehicles is obtained from the neighboring vehicle detection unit 77, and it is determined whether the distance between the motorcycle 1 and other vehicles preceding or following the motorcycle 1 is equal to or shorter than a predetermined threshold value. Note that the threshold values regarding the vehicle speed and the distance are appropriately set without particularly limiting to a specific numerical value. If the vehicle speed is equal to or lower than the threshold value, and the distance from other vehicles preceding or following the motorcycle 1 is equal to or shorter than the threshold value, the projector control unit 71 determines that a traffic jam occurs. In this case, the projector control unit 71 performs control such that the light-emitting elements 600 of the light sources 60 of each projector 6 emit weak light or are turned off.

Further, whether the light is turned off or weakened may be set by a rider in advance or depending on circumstances. In addition, the threshold value of the vehicle speed and the threshold value of the distance from other vehicles may be set individually in two stages. In this case, the projector control unit 71 may perform control such that the light is weakened when the vehicle speed or the distance from other vehicles becomes equal to or lower than a first-stage threshold value, and the light is turned off when the vehicle speed or the distance from other vehicles becomes equal to or lower than a second-stage threshold value smaller than the first-stage threshold value.

As described above, according to the embodiments of the present invention, the projector control unit 71 changes the projection status of the light pattern P projected onto the road surface G depending on a travel state of the motorcycle 1, a manipulation for the motorcycle 1, and conditions of other vehicles neighboring to the motorcycle 1. In this configuration, it is possible to inform other neighboring drivers of the travel state of the motorcycle 1 even when a rider does not manipulate the projector 6.

While preferred embodiments of the invention have been described and illustrated hereinbefore, it should be understood that they are only for exemplary purposes and are not to be construed as limitations. Any addition, omission, substitution, or modification may be possible without departing from the spirit or scope of the present invention.

Although the vehicle having the conspicuity/signaling system according to the present invention is a motorcycle in the aforementioned embodiment, the present invention may also be applied to any type of vehicles without limiting to the motorcycle. The present invention may also be applied to a saddle type three-wheeled or four-wheeled vehicle. Similarly, although the conspicuity/signaling system has four projectors in the aforementioned embodiments, the conspicuity/signaling system may have any number of projectors without limiting to “four.”

The present invention is effectively applicable to a vehicle conspicuity/signaling system. According to the present invention, it is possible to inform other neighboring drivers of a travel state of a motorcycle or the like even when a rider does not manipulate the projector.

According to the present invention, it is possible to inform other drivers or pedestrians around a motorcycle of a travel state of the motorcycle (main vehicle).

What is claimed is:

1. A vehicle conspicuity/signaling system comprising:
a projector configured to project a light pattern onto a road surface; and
a control unit configured to change a projection status of the light pattern projected from the projector depending on a travel state of the vehicle.

2. The vehicle conspicuity/signaling system according to claim 1, further comprising a detection unit configured to detect the travel state of the vehicle,
wherein the control unit changes the projection status of the light pattern projected from the projector depending on the travel state detected by the detection unit.

3. The vehicle conspicuity/signaling system according to claim 2, wherein the detection unit detects at least one of a vehicle speed and an acceleration of the vehicle, and
the control unit changes the projection status of the light pattern projected from the projector depending on at least one of the vehicle speed and the acceleration detected by the detection unit.

4. The vehicle conspicuity/signaling system according to claim 2, wherein the detection unit detects a bank angle of the vehicle, and
the control unit changes the projection status of the light pattern projected from the projector depending on the bank angle of the vehicle detected by the detection unit.

5. The vehicle conspicuity/signaling system according to claim 1, further comprising a detection unit configured to detect a manipulation for the vehicle from a driver,
wherein the control unit changes the projection status of the light pattern projected from the projector depending on the manipulation for the vehicle detected by the detection unit.

6. The vehicle conspicuity/signaling system according to claim 5, wherein the control unit changes the projection status of the light pattern projected from the projector when the detection unit detects a decelerating manipulation for the vehicle.

7. The vehicle conspicuity/signaling system according to claim 5, wherein the control unit changes the projection status of the light pattern projected from the projector when the detection unit detects at least one of a manipulation for changing a travel route of the vehicle and a manipulation for the direction indicator.

8. The vehicle conspicuity/signaling system according to claim 1, further comprising a distance detection unit configured to detect a distance from a neighboring vehicle,
wherein the control unit changes the projection status of the light pattern projected from the projector depending on the distance from other vehicles detected by the distance detection unit.

9. The vehicle conspicuity/signaling system according to claim 8, wherein the control unit changes the projection status of the light pattern projected from the projector when a relative velocity to a neighboring vehicle is equal to or higher than a threshold value.

10. The vehicle conspicuity/signaling system according to claim 8, wherein the control unit changes the projection status of the light pattern projected from the projector when a relative velocity to a neighboring vehicle is equal to or lower than the threshold value.

11. The vehicle conspicuity/signaling system according to claim 8, wherein the control unit changes the projection status of the light pattern projected from the projector when any other vehicle trying to overtake is detected.

12. The vehicle conspicuity/signaling system according to claim 8, wherein the control unit controls the projector such that the light pattern is projected to indicate outer edges of an area which includes a position of the vehicle and is larger than the vehicle.

13. The vehicle conspicuity/signaling system according to claim 12, wherein the area has a trapezoidal shape widening forward of the vehicle.

14. The vehicle conspicuity/signaling system according to claim 12, further comprising a detection unit configured to detect a vehicle speed of the vehicle,
wherein the control unit changes a size of the area depending on the vehicle speed of the vehicle detected by the detection unit.

15. The vehicle conspicuity/signaling system according to claim 12, further comprising a detection unit configured to detect a bank angle of the vehicle,
wherein the projection direction of the light pattern from the projector is changed depending on the bank angle of the vehicle detected by the detection unit.
